(19) United States
(12) Patent Application Publication
(10) Pub. No.: US 2006/0044129 A1
(43) Pub. Date: Mar. 2, 2006

(54) Facilitating signaling in a vehicle

(76) Inventor: Vipul M. Patel, Livonia, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/930,465

(22) Filed: Aug. 31, 2004

(51) Int. Cl. B60Q 1/34

(52) U.S. Cl. 340/475; 340/465

(57) ABSTRACT

A signal control system for a vehicle includes one or more indicator lights, and a steering wheel having a manually operable switch mounted thereon for activating at least one of the indicator lights. These steering wheel switches are easier to reach and activate, and less complex to incorporate into a vehicle, than a turn signal stalk.

### FIELD OF THE INVENTION

The present invention relates generally to vehicle control systems, and more particularly to vehicle turn signal control systems.

### BACKGROUND OF THE INVENTION

When the driver of a vehicle intends to make a left or right turn, he or she may activate a turn signal stalk mounted to the vehicle steering column. When the stalk is lifted, a switch is typically activated to turn on front and rear signal lights on the right side of the vehicle, thereby indicating a right turn. Depressing the stalk typically causes the switch to activate lights indicating a left turn. When the vehicle completes the turn, a mechanism associated with the steering column returns the stalk to a neutral position.

When a driver proceeds to signal a turn, he or she typically releases the vehicle steering wheel and reaches away from it to raise or lower the turn signal stalk. The discomfort and inconvenience associated with conventional turn signals discourages drivers from using vehicle turn signals.

### SUMMARY OF THE INVENTION

The present invention, in one embodiment, is directed to a signal control system for a vehicle. The system includes one or more indicator lights, and a steering wheel having a manually operable switch mounted thereon for activating at least one of the indicator lights.

In another implementation, a user-implemented method of signaling in a vehicle includes manually activating a switch on a steering wheel of the vehicle to activate an indicator light of the vehicle.

In yet another embodiment, a steering wheel for a vehicle includes a manually operable switch mounted thereon for controlling one or more signal lights of the vehicle.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a signal control system for a vehicle according to one embodiment of the present invention;

FIG. 2 is a plan view of a vehicle steering wheel according to one embodiment of the present invention;

FIG. 3 is a plan view of a vehicle steering wheel according to one embodiment of the present invention; and

FIG. 4 is a plan view of a vehicle steering wheel according to one embodiment of the present invention.

### DETAILED DESCRIPTION OF EXEMPLARY EMBODIMENTS

The following description of various embodiments of the present invention is merely exemplary in nature and is in no way intended to limit the invention, its application, or uses. For purposes of clarity, the same reference numbers may be used in the drawings to identify similar elements. As used herein, the term module and/or device refers to an application specific integrated circuit (ASIC), an electronic circuit, a processor (shared, dedicated, or group) and memory that execute one or more software or firmware programs, a combinational logic circuit, or other suitable components that provide the described functionality.

Although embodiments of the present invention are described in connection with a vehicle turn signal control system, the invention is not so limited. Embodiments also are contemplated in connection with vehicle emergency flashers, headlight intensity switching, and other vehicle lighting and/or signaling functions that could be controlled using one or more switches mounted on a steering wheel as further described below.

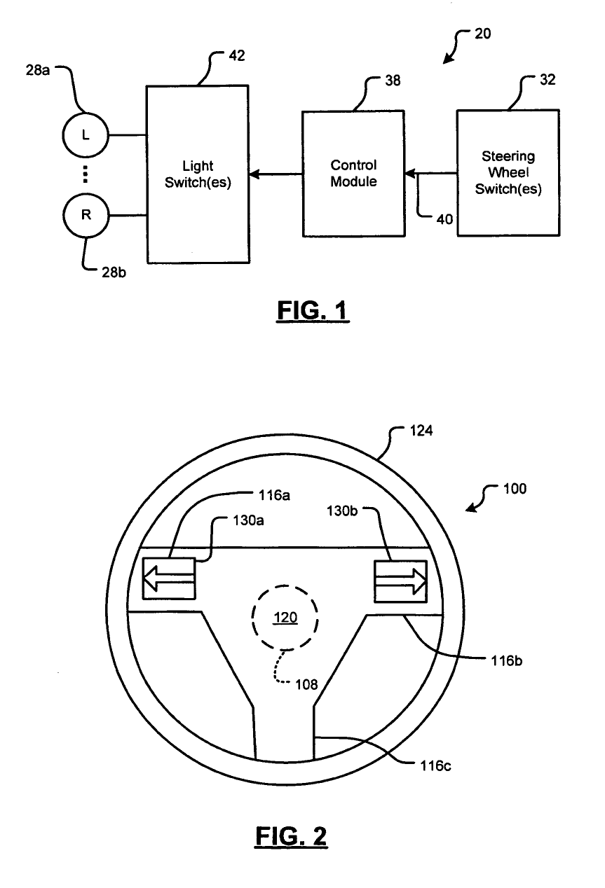

A configuration of a signal control system for a vehicle is indicated generally in FIG. 1 by reference number 20. The system 20 includes one or more indicator lights 28. As shown in FIG. 1, the system 20 includes a left turn light 28a and a right turn light 28b. Cars, trucks and other vehicles typically include at least left and right front and rear indicator lights, as well as indicator lights inside the vehicle for signaling to the driver when a signal light on the vehicle exterior is activated. Accordingly, more than two lights 28 are contemplated in many other configurations.

As further described below, a steering wheel of the vehicle includes one or more manually operable switches 32 mounted thereon for activating the indicator lights 28. It should be noted generally that where a switch is described in this specification and in the claims as being “mounted thereon” relative to a steering wheel, such description should be construed to mean that the switch is operable via means accessible on or near a surface of the steering wheel. Thus a switch may be “mounted thereon” relative to a steering wheel where the switch is manually operable, for example, by pressing a button embedded in the steering wheel.

The switch(es) 32 control operation of the signal lights 28 via a turn signal control assembly 38 and one or more light switches 42. The control module 38 selectively activates an indicator light 28 when a user activates a manually operable switch 32. The control module 38 also may deactivate a manually activated switch 32 upon completion of a turn by the vehicle.

In the configuration shown in FIG. 1, the turn signal control module 38 may selectively activate an indicator light 28 upon activation of a manually operable switch 32 and may thereafter deactivate the switch 32 in response to a signal indicating completion of a turn by the vehicle. The control assembly 38 may include one or more sensors that sense completion of a turn and signal the control module(s) accordingly. For example, differences in wheel rotation detected by an anti-lock braking system (ABS) could be used to indicate whether a turn has been completed. A turn signal control module that switches off a turn signal indicator is described in U.S. patent application Ser. No. ______, (Attorney Docket No. GP-304346), filed on the same date as the present application and entitled “Controlling Turn Signaling In a Vehicle”, the disclosure of which is incorporated herein by reference in its entirety.

In the configuration shown in FIG. 1, the steering wheel switch(es) 32 are electrically connected with the control module 38 via one or more connections 40. The connection(s) 40 may include one or more resistance ladders. When a switch 32 is activated, a signal related to a differential resistance may be transmitted to the control assembly 38, which controls the switch(es) 42 in accordance with the signal.

In other configurations the turn signal control module 38 may include electrical, mechanical and/or electromechanical members. For example, the control module 38 may include a turn signal flasher that periodically switches the light switch(es) 42 on and off to cause one of the signal lights 28 to flash on and off, as known in the art. The control module 38 also may include a canceling mechanism mounted on the steering column 108. As the vehicle completes a turn, rotation of the vehicle steering column 108 may activate the canceling mechanism to deactivate an activated switch 32.

An exemplary configuration of a steering wheel is indicated generally in FIG. 2 by reference number 100. The steering wheel 100 is mounted to a steering column 108 (indicated in phantom). A plurality of struts 116 extend generally from an area 120 mounted over the steering column 108 to support a rim 124 that can be grasped by a user to steer the vehicle. One or more switches 32 are manually operable via push buttons 130a and 130b mounted on a left-hand strut 116a and a right-hand strut 116b respectively. The buttons 130a and 130b are operable by the user to trigger operation respectively of left turn light 28a and right turn light 28b. The push buttons 130 are sufficiently close to the rim 124 such that the user can press a button 130 with one hand while holding the rim 124 with the same hand. Thus, for example, when a user wishes to signal a right turn, he or she may extend a right-hand finger or thumb to depress the button 130b while keeping the right hand on the rim 124. The user may also manually deactivate the button 130b (for example, before the button 130b is automatically deactivated as previously described) by depressing the button 130b to release it from a depressed position.

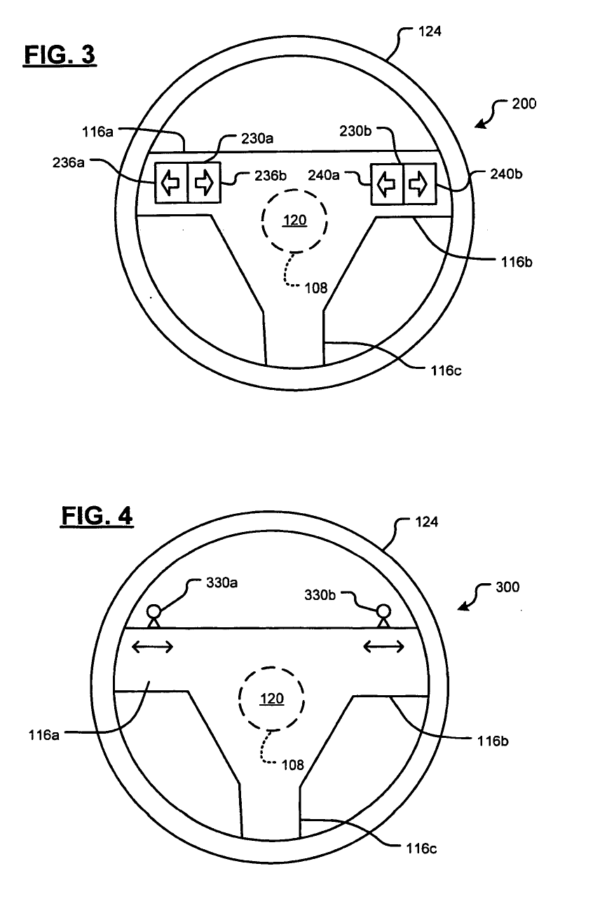

Another exemplary configuration of a steering wheel is indicated generally in FIG. 3 by reference number 200. One or more switches 32 are manually operable via rocker buttons 230a and 230b mounted, for example, in opposed relationship on left-hand strut 116a and right-hand strut 116b respectively. The buttons 230a and 230b are operable by the user to trigger operation of left turn light 28a and right turn light 28b. The rocker buttons 230 are sufficiently close to the rim 124 such that the user can rock a button 230 with one hand while holding the rim 124 with the same hand. The rocker button 230a includes left and right sides 236a and 236b. The rocker button 230b includes left and right sides 240a and 240b. A rocker left side 236a or 240a may be depressed to activate operation of left turn light 28a. A rocker right side 236b or 240ab may be depressed to activate operation of right turn light 28b. In another configuration, a pair of push buttons may be opposedly mounted on each of the struts 116a and 116b to provide switching similar to or the same as that provided by the rocker buttons 230.

Another exemplary configuration of a steering wheel is indicated generally in FIG. 4 by reference number 300. One or more switches 32 are manually operable via toggles 330a and 330b mounted, for example, in opposed relationship on left-hand strut 116a and right-hand strut 116b respectively. The toggles 330a and 330b are operable by the user to trigger operation of left turn light 28a and right turn light 28b. The toggles 330 are sufficiently close to the rim 124 such that the user can push or pull a toggle 330 with one hand while holding the rim 124 with the same hand. A toggle 330 may be pushed or pulled toward the left or right to activate operation of left turn light 28a or right turn light 28b respectively. As shown in FIG. 4, each toggle 330 is operable to activate left- or right-hand signaling. In another configuration, the toggle 330a may be operable to activate left-hand signaling only, and the toggle 330b may be operable to activate right-hand signaling only. It can be appreciated that manually operable switches can be provided in a variety of arrangements, and can be activated in many different ways, in addition to the foregoing configurations.

Configurations of the foregoing system can allow a driver to signal a turn intuitively, e.g., by pressing or rocking a button on the same side of the steering wheel as the direction in which the turn is to be made. The driver does not need to remove a hand from or reach behind the steering wheel to activate signaling. The foregoing manually operable switches are easier to reach and activate, and less complex to incorporate into a vehicle, than a turn signal stalk. Additionally, because the foregoing switches can be arranged to make it comfortable for a user to use them, many drivers may find it convenient to make more frequent and regular use of vehicle turn signals than would be the case with a conventional signaling stalk.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and the following claims.

What is claimed is:

1. A signal control system for a vehicle comprising:
one or more indicator lights; and
a steering wheel having a manually operable switch mounted thereon for activating at least one of said indicator lights.

2. The system of claim 1 further comprising a turn signal control module that selectively activates said at least one indicator light upon activation of the manually operable switch.

3. The system of claim 2 wherein said turn signal control module deactivates said manually operable switch upon completion of a turn by the vehicle.

4. The system of claim 1 wherein said manually operable switch is positioned on said steering wheel such that a user can use a hand to activate said switch while holding said steering wheel with the same hand.

5. The system of claim 1 wherein said steering wheel comprises a strut on which said manually operable switch is mounted.

6. The system of claim 1 wherein said manually operable switch comprises at least one of a push button, a rocker button, and/or a toggle.

7. The system of claim 1 wherein said steering wheel comprises a plurality of manually operable switches mounted thereon in opposed relationship.

8. The system of claim 7 wherein mounted in opposed relationship comprises mounted on opposed sides of said steering wheel.

9. The system of claim 7 wherein mounted in opposed relationship comprises opposedly mounted on one side of said steering wheel.

10. A user-implemented method of signaling in a vehicle, comprising manually activating a switch on a steering wheel of the vehicle to activate turn indicator light of the vehicle.

11. The method of claim 10 wherein manually activating a switch comprises at least one of pressing a push button, rocking a rocker button, and toggling a toggle.

12. The method of claim 10 performed while keeping both hands on the steering wheel.

13. The method of claim 10 further comprising deactivating the switch on the steering wheel to deactivate the indicator light.

14. A steering wheel for a vehicle comprising a manually operable switch mounted thereon for controlling one or more signal lights of the vehicle.

15. The steering wheel of claim 14 further comprising a strut on which said manually operable switch is mounted.

16. The steering wheel of claim 14 wherein said manually operable switch comprises at least one of a push button, a rocker button, and/or a toggle.

17. The steering wheel of claim 14 further comprising a plurality of manually operable switches mounted thereon in opposed relationship.

18. The steering wheel of claim 14 wherein said switch is mounted within reach of a hand while the hand holds said steering wheel.
